(19) United States
(12) Patent Application Publication
(10) Pub. No.: US 2003/0069733 A1
(43) Pub. Date: Apr. 10, 2003

(54) Voice control method utilizing a single-key pushbutton to control voice commands and a device thereof

(76) Inventor: Ryan Chang, Tu Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/968,029

(22) Filed: Oct. 2, 2001

(51) Int. Cl. G10L 21/00

(52) U.S. Cl. 704/275

(57) ABSTRACT

The present invention proposes a voice control method and a device thereof. A single-key pushbutton is used to control operations of a voice command module and a voice control host. A voice input unit is used to input voice command message given out by a user, and convert it into digital information. The voice command module receives the voice command message of the voice input unit, and compares pre-stored voice command messages to generate a corresponding voice command code and a preset voice command message. The voice control host receives the preset voice command message and the corresponding voice command code, and controls action of a controlled equipment according to the voice command code. A voice output unit converts the preset voice message sent out by the voice control host into an analog signal, and amplifies and outputs them, thereby guiding the user or giving out a voice control command.

### FIELD OF THE INVENTION

The present invention relates to a voice control method utilizing a single-key pushbutton to control voice commands and a device thereof and, more particularly, to a voice control method utilizing a single-key pushbutton to input voice commands for controlling equipments such as hi-fis and radio sets and a device thereof.

### BACKGROUND OF THE INVENTION

Along with continual progress of scientific technology, voice control has gradually replaced conventional mechanical operation as medium of control. Existent voice control techniques range from voice control of mobile phone to extensive application of information appliance (IA) such as a personal digital assistant (PDA). In the predictable future, voice control technique will become the mainstream medium of control. Customers no longer need to memorize operational steps and complicated instruction sets so that machines are no longer ice-cold and passive devices. With the help of voice control systems and voice commands, more friendly interfaces of human and machine can be provided to let human lives be more entertaining and vivid.

Additionally, along with more and more time spent in car, people start expecting a car with more functions among which transportation is only a basic one. For customers, how to utilize advanced techniques to solve problems in life or work is the real requirement of an ideal car. However, the more added value and functions in a car, the more complicated the operations. In order to lessen the burden of reading complicated manuals and mastering relevant instructions and operations, voice control technique has been applied to conventional cars gradually. Based on this point, the present invention aims to provide several sets of voice control modules of car having the highest ratio of identification.

### SUMMARY OF THE INVENTION

The primary object of the present invention is to provide a voice control method utilizing a single-key pushbutton to control voice commands and a device thereof, wherein user's voice commands stored in advance are utilized to control actions of a controlled equipment, hence increasing the ratio of identification of voice control.

The secondary object of the present invention is to provide a voice control method utilizing a single-key pushbutton to control voice commands and a device thereof, wherein a single-key pushbutton is utilized to control functional operations of a voice control device, and a user is guided to control with voice without the aid of eyes. Therefore, the present invention can apply to cars to achieve the object of safety.

Another object of the present invention is to provide a voice control method utilizing a single-key pushbutton to control voice commands and a device thereof, wherein voice command codes are used to consistently control various kinds of controlled equipments without the need of providing a voice control device for each equipment, thereby saving the resource.

Yet another object of the present invention is to provide a voice control method utilizing a single-key pushbutton to control voice commands and a device thereof, wherein voice commands can be easily added and deleted through guidance of voice, hence simplifying management and operational steps of voice command.

Still yet another object of the present invention is to provide a voice control method utilizing a single-key pushbutton to control voice commands and a device thereof, wherein several hundreds of sets of voice control commands commonly used presently are simplified into 18 sets of commands having the highest ratio of identification and effect of voice control, thereby achieving the object of using the least voice commands to control the most functions.

To achieve the above objects, the present invention provides a voice control method utilizing a single-key pushbutton to control voice commands and a device thereof, wherein a single-key pushbutton is used to control operations of a voice command module and a voice control host. The voice command module records and stores user's voice command messages in advance. Each voice command message corresponds to a voice command code, which can be used by the voice control host to control actions of a controlled equipment. With the voice command module comparing the user's voice command message, a voice command code is sent out to control the voice control host, thereby letting a controlled equipment act.

A voice control device utilizing a single-key pushbutton to control voice commands of the present invention uses a voice input unit to input a voice command message given out by a user, and converts the voice command message into digital information. A voice command module is used to receive the voice command message of the voice input unit, and to compare and search pre-stored voice command messages to generate a corresponding voice command code and a preset voice command message. A voice control host is used to receive the preset voice command message and the corresponding voice command code of the voice command module, and to control actions of a controlled equipment according to the voice command code. Finally, a voice output unit is used to convert the preset voice message sent out by the voice control host into analog signals, and to amplify the analog signals and give out voice, thereby guiding the user or giving out a voice control command.

The various objects and advantages of the present invention will be more readily understood from the following detailed description when read in conjunction with the appended drawing, in which:

### BRIEF DESCRIPTION OF THE DRAWINGS

FIG. 1 is a circuit architecture diagram of a voice control device utilizing a single-key pushbutton to control voice commands of the present invention;

FIG. 2 is a circuit block diagram of a voice input unit in a voice control device of the present invention;

FIG. 3 is a circuit block diagram of a voice command module in a voice control device of the present invention;

FIG. 4 is a circuit block diagram of a voice control host in a voice control device of the present invention;

FIG. 5 is a circuit block diagram of a voice output unit in a voice control device of the present invention;

FIG. 6 is a flowchart of using a single-key pushbutton to control inputting function of voice command of the present invention;

FIG. 7 is a flowchart of using a single-key pushbutton to control browsing function of voice command of the present invention;

FIG. 8 is a flowchart of using a single-key pushbutton to control adding function of voice command of the present invention;

FIG. 9 is a flowchart of a certification procedure of the adding function of voice command of the present invention; and

FIG. 10 is a flowchart of using a single-key pushbutton to control deleting function of voice command of the present invention.

### DETAILED DESCRIPTION OF THE PREFERRED EMBODIMENTS

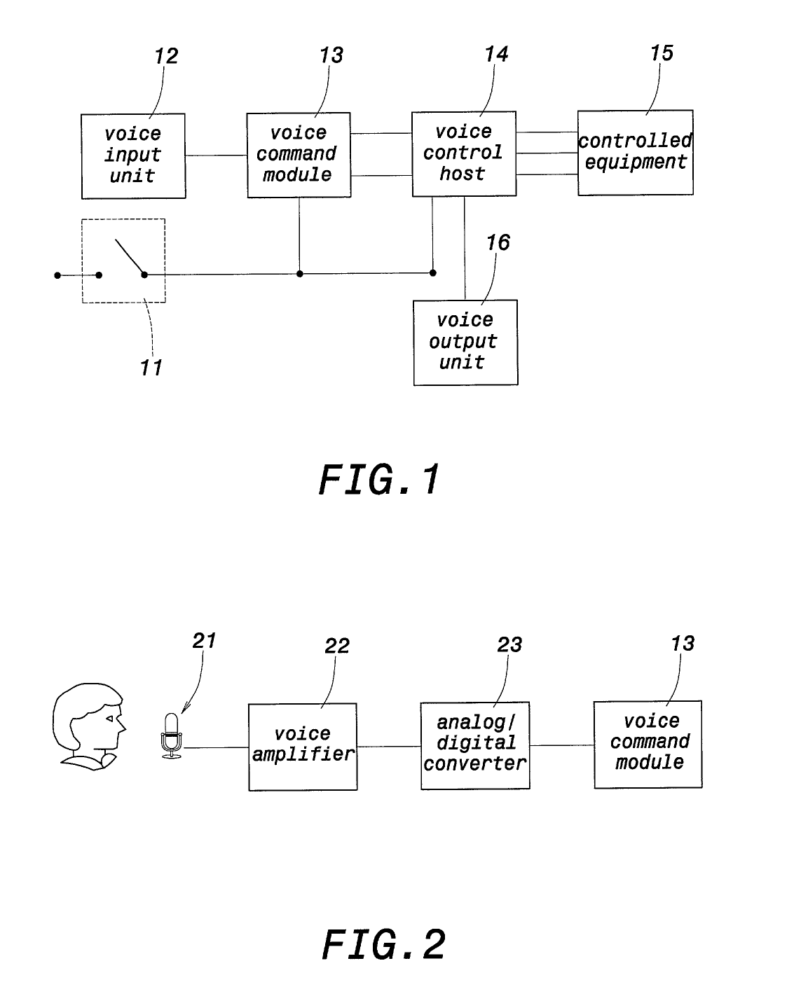

As shown in FIG. 1, a voice control device of the present invention comprises a single-key pushbutton 11, a voice input unit 12, a voice command module 13, a voice control host 14, at least a controlled equipment 15, and a voice output unit 16. The single-key pushbutton 11 is used to control the voice command module 13 and the voice control host 14 to perform inputting function, browsing function, adding function, or deleting function of voice command. The voice input unit 12 is used to input a voice command message given out by a user, and to convert it into digital information. The voice command module 13 is used to receive the voice command message of the voice input unit 12, and to compare and search pre-stored voice command messages to generate a corresponding voice command code and a preset voice command message. The voice control host 14 is used to receive the preset voice command message and the corresponding voice command code of the voice command module 13, and to control action of the controlled equipment 15 according to the voice command code. The controlled equipment 15 can be a radio set, a CD player, or a car guidance equipment. The voice output unit 16 is used to convert the preset voice message sent out by the voice control host 14 into analog signals, and to amplify the analog signals and give out voice, thereby guiding the user or giving out a voice control command.

A voice control method utilizing a single-key pushbutton to control voice commands of the present invention utilizes the single-key pushbutton 11 to control inputting function, browsing function, adding function, or deleting function of voice command of the voice command module 13 and the voice control host 14. The voice command module 13 records and stores user's voice command messages in advance. Each voice command message corresponds to a voice command code, which can control a certain action of the controlled equipment 15. With the voice command module 13 comparing the user's voice command messages, a voice command code is sent out to control the voice control host 14, thereby letting the controlled equipment 15 act and achieving the object of voice control.

As shown in FIG. 2, the voice input unit 12 in the voice control device utilizing a single-key pushbutton to control voice commands of the present invention at least comprises a microphone 21, a voice amplifier 22, and an analog/digital converter 23. The microphone 21 is used to receive a user's voice command message. The voice amplifier 22 is used to amplify the voice command message received by the microphone 21. The analog/digital converter 23 is used to convert the voice command message amplified by the voice amplifier 22 into digital information, and then transfer it to the voice command module 13.

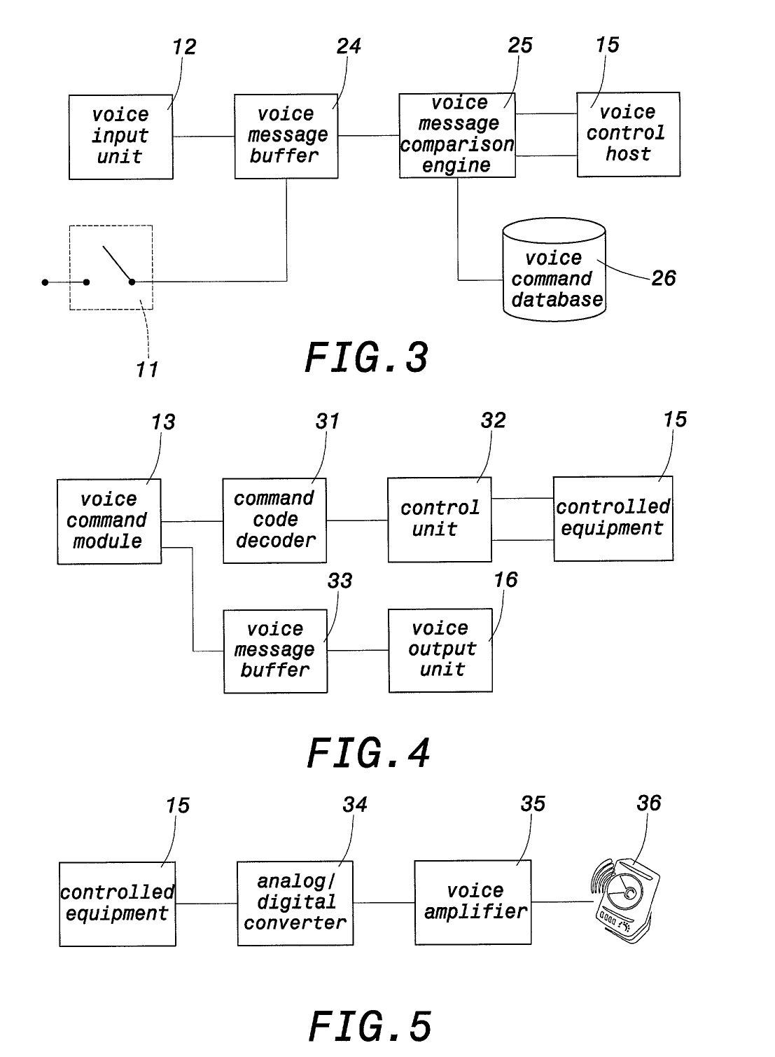

As shown in FIG. 3, the voice command module 14 of the present invention at least comprises a voice message buffer 24, a voice message comparison engine 25, and a voice command database 26. The voice message buffer 24 is used to temporarily store the inputted user's voice command message from the voice input unit 12 under the control of the single-key pushbutton 11. The voice message comparison engine 25 is used to search and compare the user's voice messages in the voice command database 26 to determine whether there is a voice message compatible with the user's voice command message in the voice message buffer 24. If the answer is positive, a preset voice command message and a corresponding voice command code are retrieved and sent to the voice control host 14. The voice command database 26 is used to store preset voice command messages and user's voice command messages, each preset voice command message corresponding to a voice command code.

As shown in FIG. 4, the voice control host 14 of the present invention at least comprises a voice command decoder 31, a control unit 32, and a voice message controller 33. The voice command decoder 31 is used to decode the voice command code into a control signal, and then transfer it to the control unit 32 to control the action of the controlled equipment 15. The control unit 32 is used to control the action of turning on, turning off, or special functions of the controlled equipment 15. The voice message controller 33 is controlled by the single-key pushbutton 11 to send out the preset voice message for guiding the user to the voice output unit 16, or to send the preset voice command message from the voice command module 14 to the voice output unit 16.

As shown in FIG. 5, the voice output unit 16 of the present invention at least comprises a digital/analog converter 34, a voice amplifier 35, and a loudspeaker 36. The digital/analog converter 34 is used to convert the preset voice command message from the voice control host 15 into an analog voice message. The voice amplifier 35 is used to amplify the analog voice message converted by the digital/analog converter 35. The loudspeaker 36 is used to give out the voice message amplified by the voice amplifier 35 so that the user can hear guidance voice for operation or inputted voice command steps.

Several hundreds of voice control modules used in car or home are researched in the present invention to obtain the following rules.

1. Phrases composed of two words are more difficult to identify in identification of voice control.

2. In order to enhance the ratio of identification, it is necessary to increase the number of words. However, phrases composed of too many words are less colloquial. Therefore, the number of words of phrases having the best effect of voice control is about 3-4.

3. Phrases of voice control cannot have too many breaths or be mixed with Chinese and English.

4. It is better that the way of arranging verbs in front of nouns is adopted for phrases of voice control.

The following table shows items of voice control according to a preferred embodiment of the present invention used in a car.

| Main menu | | Sub menu |
|---|---|---|
| (1) Radio set | (4) switching channel | switching memory band, |
| | | FM1 > FM2 > AM |
| | (5) next station | jumping to the next memory station |
| | (6) searching stations | arbitrarily searching stations |
| (2) CD player | | |
| | (7) next song | jumping to the next song |
| | (8) changing CD | jumping to the next CD |
| | (9) MP3 | |
| | (10) playing from scratch | jumping to the first song |
| (3) Car guidance | | |
| | (11) zoom in | |
| | (12) zoom out | |
| | (13) destination | |
| | (14) present position | |

| | |
|---|---|
| (15) Traffic report | traffic report of station or voice news report |
| (16) Louder | increasing the volume |
| (17) Lower | decreasing the volume |
| (18) Mute | mute |

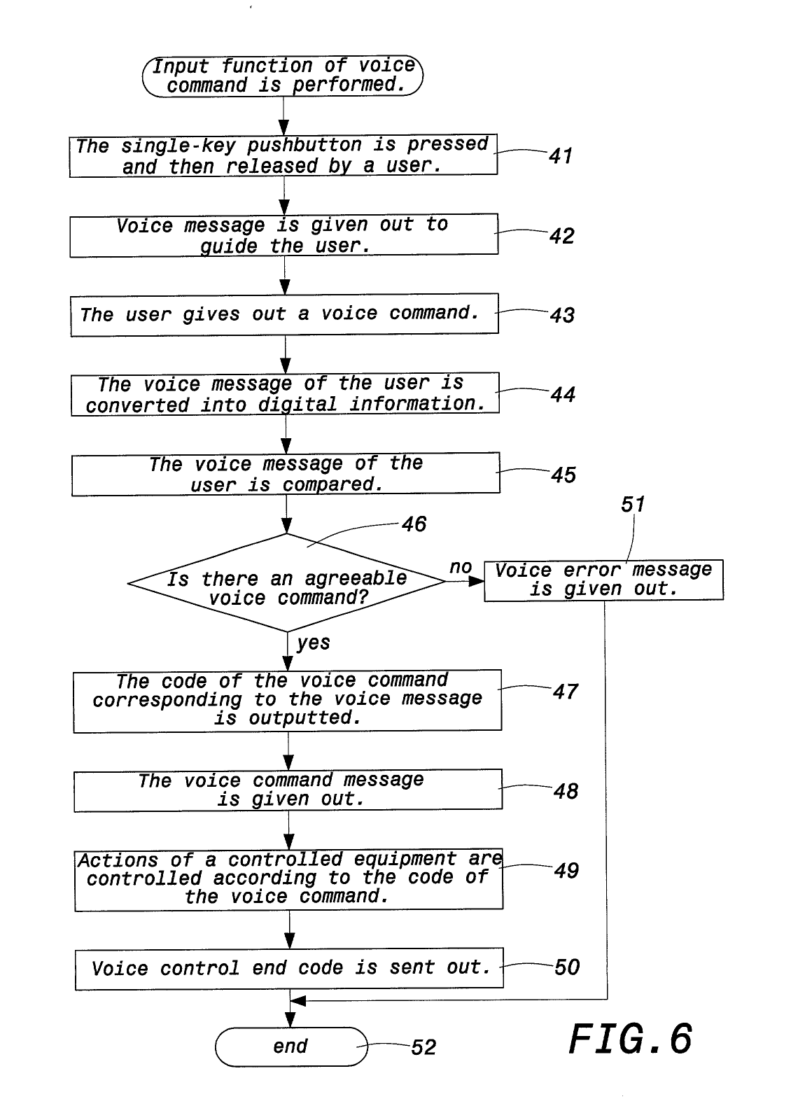

As shown in FIG. 6, a flowchart of using a single-key pushbutton to input voice commands of the present invention comprises the following steps.

Step 41: A user presses the single-key pushbutton 11 and then releases it;

Step 42: The voice control host gives out a preset voice message to guide the user, e.g. “Please say a command.”;

Step 43: The user gives out a voice command message, e.g. “The radio set”;

Step 44: The voice command module 13 converts the voice message of the user is into digital information;

Step 45: The voice command module 13 compares the digital information with the user's voice command messages in the voice command database 26;

Step 46: Whether there is an agreeable voice command is judged. If the answer is positive, the next step is performed; otherwise, Step 51 is jumped to;

Step 47: The voice command module 13 outputs the voice command code corresponding to the voice command and the preset voice command message to the voice control host 14;

Step 48: The voice control host 14 gives out the preset voice command message, e.g., “The radio set is activated.”;

Step 49: The voice control host 14 controls action of the controlled equipment 15 according to the voice command code;

Step 50: A voice control end code is sent out, and Step 52 is then jumped to;

Step 51: The voice control host 14 gives out a voice error message, e.g., “Sorry, the voice command is vague.”;

Step 52: Inputting function of voice command is ended.

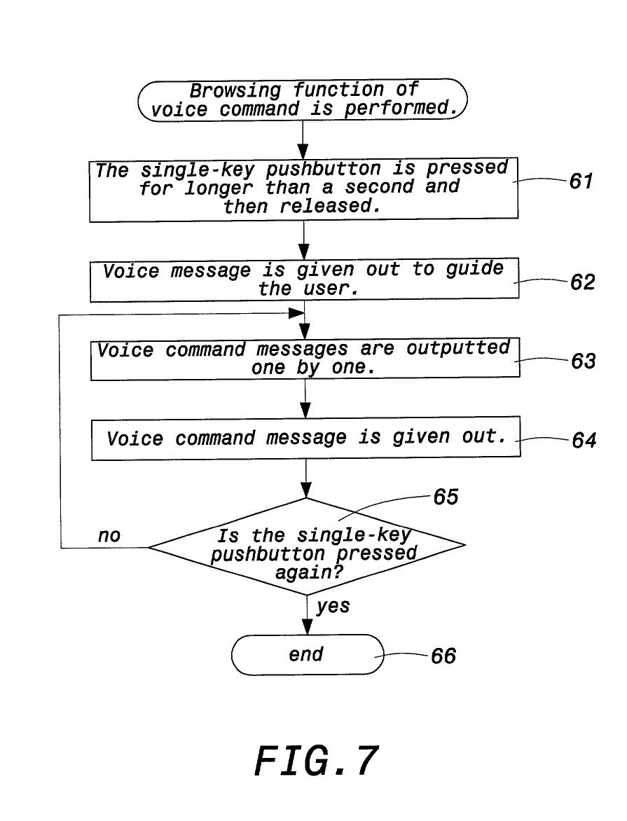

FIG. 7 is a flowchart of using a single-key pushbutton to control browsing function of voice command of the present invention. In the present invention, the single-key pushbutton 11 is pressed for a period of time (e.g., 1 second) and then released to activate browsing function of voice command. The browsing function of voice command of the present invention comprises the following steps.

Step 61: The single-key pushbutton 11 is pressed for longer than a unit time (e.g., a second) and then released to activate the browsing function of voice command;

Step 62: The voice control host 14 gives out a preset voice message to guide a user, e.g., “Browsing command”;

Step 63: The voice command module 13 outputs voice command messages in the voice command database 26 one by one to the voice control host 14;

Step 64: The voice control host 14 gives out a preset voice command message, e.g., “the radio, the next station, . . . ”;

Step 65: Whether the single-key pushbutton is pressed again is judged. If the answer is positive, the next step is performed; otherwise, Step 63 is jumped back to;

Step 66: Browsing function of voice command is ended;

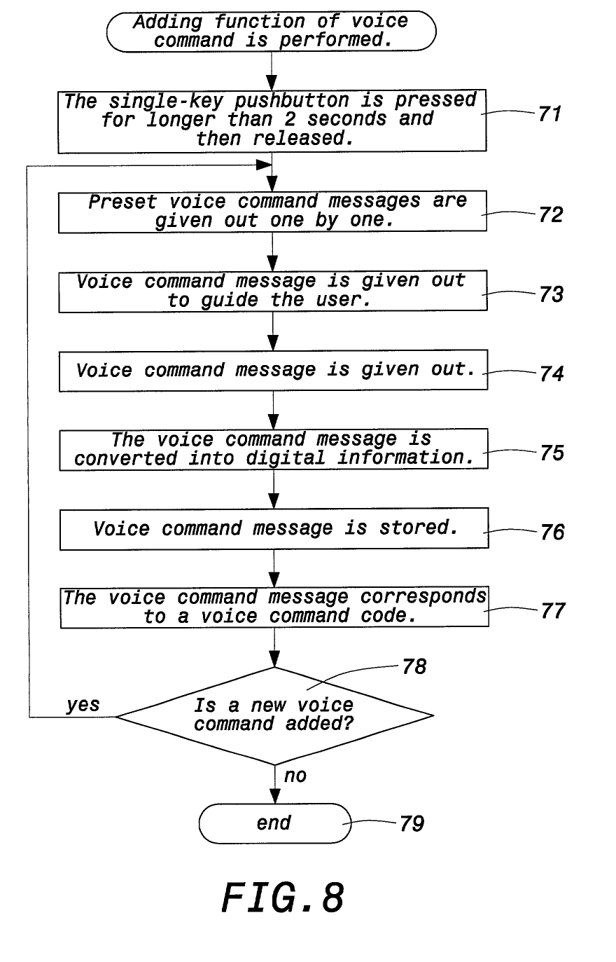

As shown in FIG. 8, a flowchart of using a single-key pushbutton to control adding function of voice command of the present invention comprises the following steps.

Step 71: The single-key pushbutton 11 is pressed for longer than a unit time (e.g., 2 seconds) and then released to activate the adding function of voice command;

Step 72: The voice command module 13 outputs preset voice command messages in the voice command database 26 one by one to the voice control host 14;

Step 73: The voice control host 14 gives a preset voice command message to guide the user, e.g., “Please say a command, the radio set”;

Step 74: The user gives out a voice command message;

Step 75: The voice command module converts the voice command message of the user into digital information;

Step 76: The voice command module 13 stores the digital information into the voice command database 26;

Step 77: The added voice command message corresponds to a voice command code;

Step 78: Whether a new voice command is added again is judged. If the answer is positive, Step 72 is jumped back to; otherwise, the next step is performed;

Step 79: Adding function of voice command is ended.

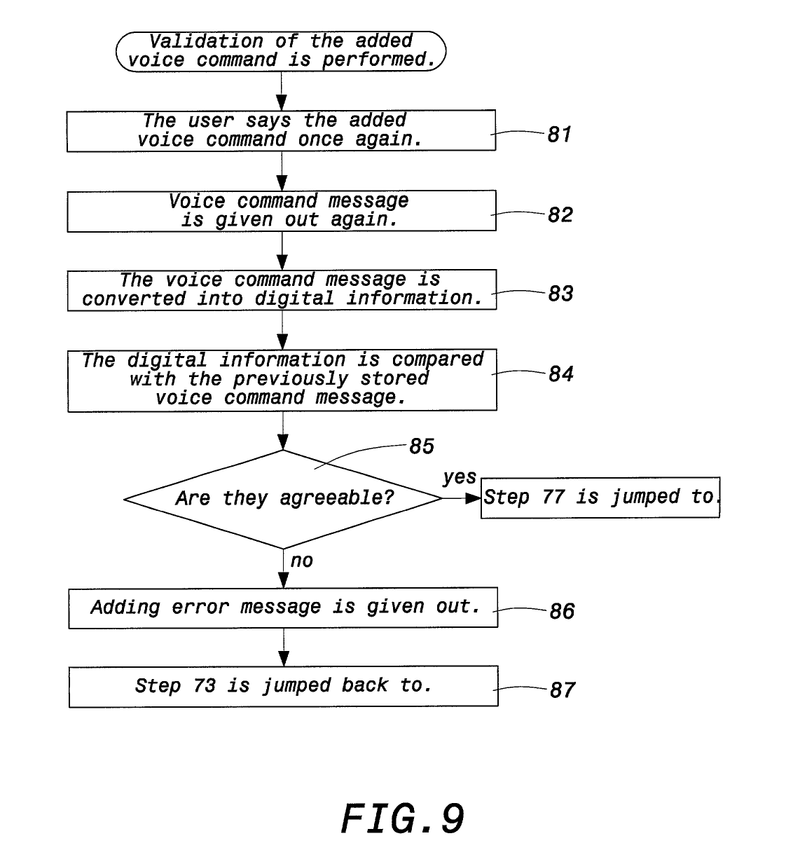

As shown in FIG. 9, a flowchart of a certification procedure of the adding function of voice command of the present invention comprises the following steps between Step 76 and Step 77 of the adding function of voice command.

Step 81: The voice control host 14 gives out a preset voice message to guide the user to say the added voice command once again, e.g., “Please repeat once more.”;

Step 82: The user gives the voice command message once again, e.g., “The radio set”;

Step 83: The voice command module 13 converts the voice command message of the user into digital information;

Step 84: The voice command module 13 compares the digital information with the previously stored voice command message;

Step 85: Whether they are agreeable is judged. If the answer is positive, Step 77 is jumped to; otherwise, the next step is performed;

Step 86: The voice control host 14 gives out a preset adding error message, e.g., “The voice commands are different. Please perform the adding function anew.”;

Step 87: Step 73 is jumped back to for performing adding function of voice command anew.

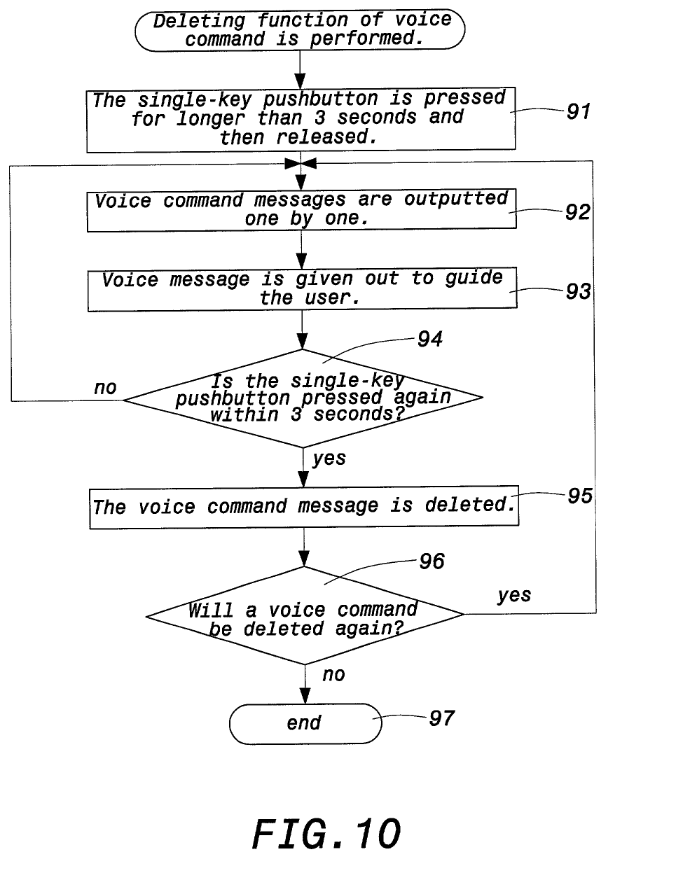

As shown in FIG. 10, a flowchart of using a single-key pushbutton to control deleting function of voice command of the present invention comprises the following steps.

Step 91: The single-key pushbutton 11 is pressed for longer than a unit time (e.g., 3 seconds) and then released to activate the deleting function of voice command;

Step 92: The voice command module 13 sends preset voice command messages in the voice command database 26 one by one to the voice control host 14;

Step 93: The voice control host 14 gives out a preset voice message to guide the user, e.g., “Command; the radio set; push the button for performing the deleting function.”;

Step 94: Whether the single-key pushbutton 11 is pressed again within the unit time is judged. If the answer is positive, the next step is performed; otherwise, Step 92 is jumped back to;

Step 95: The voice command module 13 deletes the voice command message of the user from the voice command database 26;

Step 96: Whether a voice command will be deleted again is judged. If the answer is positive, Step 92 is jumped back to; otherwise, the next step is performed;

Step 97: Deleting function of voice command is ended.

To sum up, the voice control method utilizing a single-key pushbutton to control voice commands and a device thereof of the present invention is characterized in that:

1. The present invention can utilize user's voice commands stored in advance to control actions of controlled equipments to increase ratio of identification of voice control.

2. The present invention utilizes a single-key pushbutton to control operations of a voice control device and voices to guide a user to control with voice without the aid of eyes, thereby applying to cars without doubt of safety.

3. The present invention utilizes voice command codes to consistently control various kinds of controlled equipments without the need of providing a voice control device for each controlled equipment, hence saving the resource.

4. The present invention can easily add or delete a voice command through the guidance of voice, hence simplifying management and operational steps of voice control commands.

5. The present invention simplifies several hundreds of sets of voice control commands commonly used presently into 18 sets of commands having the highest ratio of identification and the best effect of voice control, thereby achieving the object of using the least voice commands to control the most functions.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A voice control method utilizing a single-key pushbutton to control voice commands comprising the steps of:
recording voice commands of a user in advance by a voice command module;
corresponding each voice command of the user to a voice control code;
each voice control code controlling action of a controlled equipment through a voice control host;
using a single-key pushbutton to control said voice command module and said voice control host to perform inputting function, browsing function, adding function, or deleting function of voice command;
said voice command module comparing a voice command message of the user to send out a voice command code, thereby controlling said voice control host to let a controlled equipment act.

2. The voice control method utilizing a single-key pushbutton to control voice commands as claimed in claim 1, the flowchart of said inputting function of said single-key pushbutton comprising the steps of:
(a) pressing and then releasing said single-key pushbutton to activate said inputting function;
(b) said voice control host giving out a voice message to guide the user;
(c) the user giving out a voice command message;
(d) said voice command module converting the voice message of the user into digital information;
(e) said voice command module comparing said digital information with voice command messages of the user in a voice command database;
(f) judging whether there is an agreeable voice command; performing the next step if the answer is positive; otherwise jumping to Step (k);
(g) said voice command module outputting the code of the voice command corresponding to said voice message and a preset voice command message to said voice control host;
(h) said voice control host giving out the voice message of said preset voice command;
(i) said voice control host controlling actions of the controlled equipment according to said voice command code;
(j) sending out a voice command end code and then jumping to Step (1);
(k) said voice control host giving out a preset voice error message;
(l) ending the input function of voice command.

3. The voice control method utilizing a single-key pushbutton to control voice commands as claimed in claim 1, the flowchart of said browsing function of said single-key pushbutton comprising the steps of:
(a) pressing said single-key pushbutton for longer than a second and then releasing it to activate said browsing function;
(b) said voice control host giving out a voice message to guide the user;
(c) said voice command module outputting voice command messages in said voice command database one by one to said voice control host;
(d) said voice control host giving out a preset voice command message;
(e) judging whether said single-key pushbutton is pressed again by the user; performing the next step if the answer is positive; otherwise jumping back to Step (c);
(f) ending said browsing function of voice command.

4. The voice control method utilizing a single-key pushbutton to control voice commands as claimed in claim 1, the flowchart of said adding function of said single-key pushbutton comprising the steps of:
(a) pressing said single-key pushbutton for longer than 2 seconds and then releasing it to activate said adding function;
(b) said voice command module sending preset voice command messages in said voice command database one by one to said voice control host;
(c) said voice control host giving out a voice command message to guide the user;
(d) the user giving out a voice command message;
(e) said voice command module converting said voice command message into digital information;
(f) said voice command module storing said digital information into said voice command database;
(g) corresponding said added voice command message to a voice command code;
(h) judging whether a new voice command is added again, jumping back to Step (b) if the answer is positive; otherwise performing the next step;
(i) ending said adding function of voice command.

5. The voice control method utilizing a single-key pushbutton to control voice commands as claimed in claim 4, wherein said adding function can further comprise a certification procedure between Step (f) and Step (g), said certification procedure comprising the steps of:
(j) said voice control host giving out a preset voice message to guide the user to say the added voice command once again;
(k) the user giving out the voice command message once again;
(l) said voice command module converting the voice command message of the user into digital information;
(m) said voice command module comparing said digital information with the previously stored voice command message;
(n) judging whether they are agreeable, jumping to Step (g) if the answer is positive; otherwise performing the next step;
(o) said voice control host giving out a preset adding error message;
(p) jumping back to Step (c) for performing said adding function of voice anew.

6. The voice control method utilizing a single-key pushbutton to control voice commands as claimed in claim 1, the flowchart of said deleting function of said single-key pushbutton comprising the steps of:
(a) pressing said single-key pushbutton for longer than 3 seconds and then releasing it to activate said deleting function;
(b) said voice command module sending preset voice command messages in said voice command database one by one to said voice control host;
(c) said voice control host giving out a preset voice message to guide the user;
(d) judging whether said single-key pushbutton is pressed again within a unit time, performing the next step if the answer is positive; otherwise jumping back to Step (b);
(e) said voice command module deleting said voice message of the user in said voice command database;
(f) judging whether a voice command will be deleted again, jumping back to Step (b) if the answer is positive; otherwise performing the next step;
(g) ending said deleting function of voice command.

7. A voice control device utilizing a single-key pushbutton to control voice commands, comprising:
a voice input unit used to input a voice command message given out by a user and convert it into digital information;
a voice command module used to receive said voice command message of said voice input unit and to compare and search preset voice command messages to generate a corresponding voice command code and a preset voice command message;
at least a controlled equipment;
a voice control host used to receive said preset voice command message and said corresponding voice command code of said voice command module and to control actions of said controlled equipment according to said voice command code;
a single-key pushbutton used to control said voice command module and said voice control host to perform inputting function, browsing function, adding function, or deleting function of voice command; and
a voice output unit used to convert a preset voice message sent out by said voice control host into analog signals and to amplify and then output the analog signals to guide the user or to give out a voice command for control.

8. A voice control device utilizing a single-key pushbutton to control voice commands as claimed in claim 7, wherein said voice input unit further comprises at least:
a microphone used to receive a voice command message of the user;
an amplifier used to amplify said voice command message of the user received by said microphone; and
an analog/digital converter used to convert said voice command message amplified by said amplifier into digital information and to send said digital information to said voice command module.

9. A voice control device utilizing a single-key pushbutton to control voice commands as claimed in claim 7, wherein said voice command module comprises at least:
a voice command database used to store preset voice command messages and voice command messages of the user with each of said preset voice command messages corresponding to a voice command code;
a voice message buffer used to temporarily store the user's voice command messages inputted from said voice input unit; and
a voice message comparison engine used to compare the user's voice messages in said voice command database to determine whether they are compatible with the user's voice command messages of said voice message buffer, and to retrieve the preset voice command message and the corresponding voice command code and send to said voice control host if the answer is positive.

10. A voice control device utilizing a single-key pushbutton to control voice commands as claimed in claim 7, wherein said voice control host comprises at least:
a control unit used to control actions of turning on, turning off, or special functions of said controlled equipment;
a command code decoder used to decode a voice command code into a control signal and then send the control signal to said control unit for controlling actions of said controlled equipment; and
a voice message controller controlled by said single-key pushbutton to send out a preset voice message for guiding the user to said voice output unit, or to send a preset voice command message from said voice command module to said voice output unit.

11. A voice control device utilizing a single-key pushbutton to control voice commands as claimed in claim 7, wherein said voice output unit comprises at least:
a digital/analog converter used to convert a preset voice command message from said voice control host into an analog voice message;
a voice amplifier used to amplify said analog voice message converted by said digital/analog converter; and
a loudspeaker used to give out the voice message amplified by said voice amplifier.

12. A voice control device utilizing a single-key pushbutton to control voice commands as claimed in claim 7, wherein said controlled equipment can be a radio set, a CD player, or a car guidance equipment.

13. A voice control device utilizing a single-key pushbutton to control voice commands as claimed in claim 7, wherein control functions of said controlled equipment at least comprises increasing the volume, decreasing the volume, muting, changing the channel, jumping to the next station, searching stations, jumping to the next song, changing the CD, playing from the scratch, zooming in, zooming out, going to the destination, and showing the present position.
